(19) United States
(12) Patent Application Publication
(10) Pub. No.: US 2007/0248797 A1
(43) Pub. Date: Oct. 25, 2007

(54) Viscoelastic dampers for automotive door water deflectors

(76) Inventor: John Alan Petroski, Ravenna, OH (US)

Correspondence Address: FAY SHARPE LLP, 1100 SUPERIOR AVENUE, SEVENTH FLOOR, CLEVELAND, OH, 44114, US

(21) Appl. No.: 11/731,622

(22) Filed: Mar. 30, 2007

Related U.S. Application Data
(60) Provisional application No. 60/787,337, filed on Mar. 30, 2006.

(51) Int. Cl. B32B 23/02

(52) U.S. Cl. 428/194

(57) ABSTRACT

A water deflector for a vehicle door having a sheet, a strip of pressure adhesive secured to a peripheral edge of said sheet for securing the sheet to a vehicle door panel, and a central layer of foam, which is bonded to the sheet to provide viscoelastic dampening to the vehicle door.

### CLAIM OF PRIORITY

This application claims priority from Provisional Application Ser. No. 60/787,337, filed on Mar. 30, 2006.

### BACKGROUND OF THE INVENTION

The subject invention is directed to a vehicle door construction and more particularly to viscoelastic dampers for a water deflector for use therein.

Vehicle doors typically include a first outer sheet metal panel which defines the door exterior. A spaced inner sheet metal door panel reinforces the outer panel and defines a chamber or cavity which houses various mechanisms, including window operators, latches, and the like. Openings through the inner door panel allow access to such mechanisms. A trim panel covers the inner door panel and provides the decorative interior for the door.

Generally, water deflectors or protectors are joined to a face of the inner door panel. The water deflector protects the inner door trim panel, as well as components mounted thereon, from being damaged by water entering the interior of the doors. The water deflector also prevents the intrusion of air, dust and water from the inner door cavity into the passenger cabin. A permanently plastic and permanently tacky pressure-sensitive adhesive can be applied to selected areas of the deflector sheet to permit attachment to the inner door panel.

Water deflector sheets of the general type under consideration are shown and described, for example, in commonly assigned U.S. Pat. No. 5,482,343 for “Vehicle Door and Water Deflector” and U.S. Pat. No. 5,560,967 for “Sound Absorbing Automotive Water Deflector.” The disclosures of these patents are incorporated herein by reference. As shown therein, the deflector sheets generally include a layer of polyethylene foam sandwiched between one or more relatively thin flexible sheets of a suitable plastic such as polyethylene or polypropylene. This sheet construction can be processed using standard techniques and performs satisfactorily in its water deflecting function.

Water deflectors or protectors are commonly used in the automotive industry to protect inner door trim panels, as well as components mounted thereon, from being damaged by water entering the interior of the doors. Vehicle manufacturers have also been interested in achieving sound insulation through the use of such deflectors.

One type of water deflector which has been in use for some time comprises a layer of closed cell polyethylene foam sandwiched between thin layers of polyethylene film. This sheet construction can be processed using standard techniques and performs satisfactorily in its water deflecting function; however, it does not contribute significantly in terms of sound insulating qualities.

While various material combinations have been proposed for use as sound insulating water deflectors, these combinations have typically had significant drawbacks in terms of cost and/or processing difficulties. For example, it is often desirable to provide the deflectors with pocket-like bulges or non-planar sections to better conform to the surface to be protected or to accommodate mechanisms and components within the doors. Some combinations can be given such configuration only by slow and comparatively expensive thermoforming and vacuum forming techniques. Relatively inexpensive and rapid mechanical forming techniques such as described in commonly assigned U.S. Pat. Nos. 4,696,848; 4,865,791; and 4,873,132 cannot be used for certain of the proposed combinations.

As interior acoustics became important, vehicle manufacturers have also been interested in achieving sound insulation through the use of such water deflectors to restrict sound from traveling into the passenger cabin from the inner door cavity. Traditional water deflectors can help reduce sound transmission from the inner door to the passenger cabin by blocking and reflecting sound energy.

However, recently, automotive manufacturers have begun installing sound systems with increased power capabilities. As driven speaker power is increased and speakers with low frequency are used, the sound systems have become a potential contributor to noise generation. With increasing power and the ability to generate strong low frequency response, the sound systems can induce sympathetic vibration in the deflectors. This induced vibration can result in a very noticeable buzz or noise from the water deflectors. In cases such as this, the water deflectors can thus become undesired noise generators.

In light of the foregoing, it has become evident that a need exists for a water deflector sheet design that will permit obtaining both water deflecting and sound insulating/dampening characteristics and overcome the above-mentioned deficiencies and others while obtaining better and more advantageous results.

### SUMMARY OF THE INVENTION

In accordance with the subject disclosure, a water deflector is provided which has improved sound absorbing/dampening qualities. The deflector is comprised of at least one sheet or layer of high strength linear low density polyethylene, polypropylene film or foam. To be effective, the viscoelastic properties of the polyethylene, polypropylene film or foam are then modified with softer, more elastic or rubbery resins to impart dampening characteristics. The deflector may be used alone or as a composite with an open cell foam or non-woven absorber.

The use of the foregoing sheet bonded to a planar face of an open or closed celled foam produces a water deflector sheet which has a significant increase in sound absorbing/dampening qualities as compared to prior sheet constructions.

A primary object of the invention is the provision of an improved water deflector sheet construction.

Yet another object of the invention is the provision of a water deflector sheet which has significantly increased sound absorbing and dampening qualities together with characteristics which allow processing of the sheets using known techniques.

A still further object is the provision of a water deflector sheet construction which has the advantages described but which is comparatively inexpensive.

Still other non-limiting objectives and/or aspects of the present disclosure will become apparent from a reading and understanding of the description of the embodiment hereinbelow.

### BRIEF DESCRIPTION OF THE DRAWINGS

The present disclosure may take physical form in certain parts and arrangements of parts, a preferred embodiment of which will be described in detail in this specification and illustrated in the accompanying drawings which form a part of the disclosure and wherein:

FIG. 1 is a side elevational view from the interior side of a vehicle door structure incorporating the subject disclosure with portions broken away to more clearly show certain structural features;

FIG. 2 is a side elevational view showing a typical water deflector sheet construction formed in accordance with the subject disclosure; and,

FIG. 3 is a cross-sectional view taken along lines 3-3 of FIG. 2.

### DETAILED DESCRIPTION OF THE INVENTION

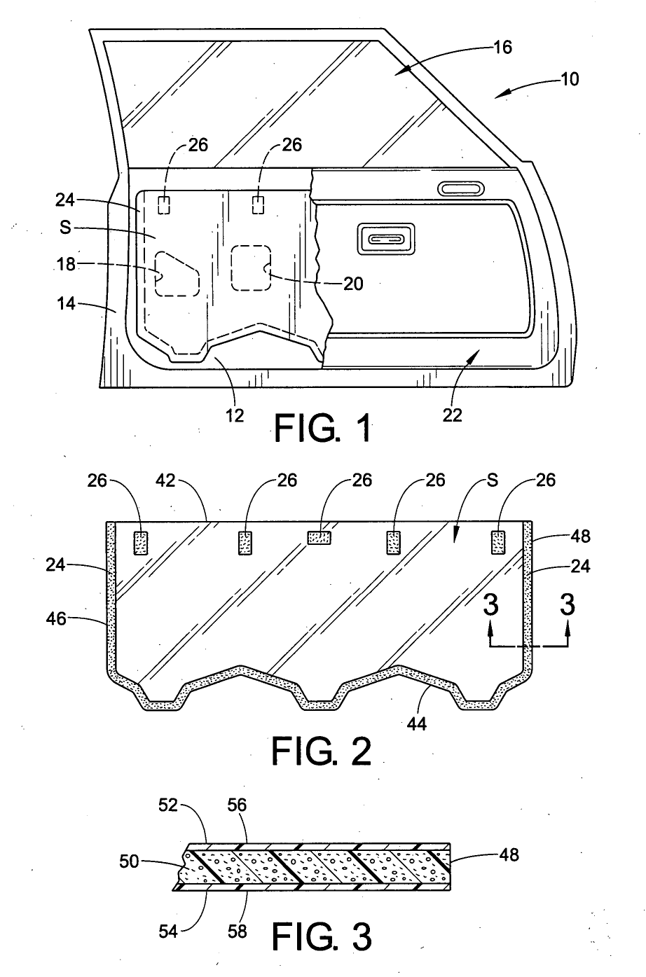

Referring more particularly to the drawings wherein the showings are for the purpose of illustrating a preferred embodiment of the disclosure only, and not for the purpose of limiting same, FIG. 1 best illustrates a typical vehicle door assembly 10 comprising spaced inner and outer door panels 12 and 14 formed from sheet metal and joined about their peripheral edge with a space or cavity formed therebetween for accommodating various internally mounted operating mechanisms such as window operators, speakers, and the like. A window 16 is arranged to move within the space between the inner and outer panels 12 and 14. The inner panel 12 is formed to have a somewhat irregular or uneven contour for housing and mounting the various mechanisms and accessories thereon and for providing optimum strength. In addition, various access openings, such as openings 18 and 20, are formed through the inner door panel to permit access to the mechanisms within the door.

The door structure thus far described is fairly typical and it is possible that the door of the subject invention could have a variety of other configurations and access openings through the inner panel provided at a variety of different locations.

Extending over the inner door panel 12 and joined thereto is a door trim panel structure 22. The door trim panel provides a decorative cover and overlay for the inner door panel and is formed from a variety of different materials, including metal and fabric combinations, molded plastic, and the like as is well known. The inner door panel 22 in such door structures is releasably connected to the sheet metal inner door panel so that access can be had to the interior of the door for maintenance and/or repair of the various mechanisms and components mounted therein. Generally, it has been the practice to provide the trim panel with hook or hook-like fastener elements on its rear surface which can enter into and engage into suitable openings formed through the inner door panel 12.

The presence of the noted openings 18, 20 and passages through the inner door panel require that steps be taken to prevent water, dust and the like from entering the interior of the door through these openings and into engagement with the door trim panel, thus potentially damaging the trim panel. For this reason, it has been the practice to use water deflector sheets which are placed on an interior surface of the door inner panel 12 to overlie and effectively close the various openings 18, 20 and the like.

The water deflector sheet is formed to have the desired peripheral shape to suitably overlie the inner door panel 12 and is releasably joined thereto by the use, for example, of a pressure sensitive adhesive located in bands or strips 24 about the outer periphery of the sheet. In FIG. 1, the deflector sheet is identified with the reference letter S and is provided with a peripheral band of suitable pressure sensitive adhesive 24 about the vertical side edges and transversely across the bottom edge. Additionally, suitable spots of pressure sensitive adhesive 26 are positioned at various locations along the top edge of or at other locations inboard on sheet S. Sheet S is shown more particularly and in greater detail in FIGS. 2 and 3 and will subsequently be described with particular reference to the improvement features of the subject disclosure. For the present, however, it should be noted that the sheet S is incorporated into the door structure to lie at least between the openings 18 and 20 and the inner trim panel 22.

With reference to FIG. 2, the peripheral shape of the water deflector sheet S is merely exemplary and can vary significantly, but generally comprises an upper edge portion 42, a lower edge portion 44, and opposite end edges 46 and 48. Various openings for the passage of wires and the like are often formed through the water deflector sheet.

As shown in FIG. 3, the particular structure of the deflector sheet S is a multi-layer composite including a central layer or sheet 50 formed of an open celled or closed celled foam. Preferably, the foam has a thickness in the range of at least about 50 to 500 mils. Bonded to at least one opposite faces 52, 54 of the central sheet of foam is a separate continuous and imperforate sheet 56 of a high strength linear low density polyethylene or polypropylene film. It should be understood that other plastics and laminates having the desired characteristics could equally well be used. The sheet of film 56 is bonded in firm, tight engagement with the foam 50 in a conventional manner through the use of flame bonding, heat lamination or the like. In the illustrated embodiment, the sheet of film 56 or 58 is bonded to the face 52 of the foam adjacent the door trim panel 22. However, it should be appreciated that another sheet of film 58 can be bonded to the opposite face 54 of the foam adjacent the inner panel 12. Preferably, the film has a thickness in the range of 1 to 10 mils. The sheet of film 56 or 58 acts to seal the central layer of foam 50 against water entering therein. A sheet of film can be installed on one or both opposed side faces 52, 54 of the foam 50.

To dampen vibrations in the sheet which may be caused by a vehicle sound system, viscoelastic properties of the film 56, 58 are modified with softer, more elastic or rubbery resins to impart desired dampening characteristics. By softening the film, it displays fewer tendencies to induced vibration thereby transforming vibrational energy into thermal energy. For example, an ethylene vinyl acetate (EVA) modified foam has an improved vibrational resistance compared to a conventional open celled or closed cell foam. In this particular example, a three millimeter (3 mm) thick, four pound (4 lb) density EVA foam was laminated to modified 0.0006 inch thick film. When tested on an actual vehicle, this deflector sheet eliminated vibration induced by high power audio speakers. The dampening effect can be further enhanced by employing a modified foam.

It should be appreciated that the above deflector is only an example of the present disclosure and that other modified foams and films can be used to obtain both water deflecting and sound insulating/dampening characteristics. Also, other combinations of sheet material and foam could be advantageously employed using its concept with the development including, for example, a sheet processed to have the desired characteristics affixed to the opposed side face faces of the foamed material.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A water deflector for a vehicle door comprising:
a sheet;
a strip of pressure adhesive secured to a peripheral edge of said sheet for securing said sheet to an associated vehicle door panel; and,
a layer of foam, which is bonded to said sheet to provide viscoelastic dampening to said vehicle door.

2. The water deflector of claim 1, further comprising a plurality of pressure sensitive adhesive bands positioned on a face of said water deflector.

3. The water deflector of claim 1, wherein said sheet comprises an upper edge portion, a lower edge portion, and end edge portions between said upper and lower edge portions.

4. The water deflector of claim 1, wherein said foam layer comprises an open-celled foam.

5. The water deflector of claim 1, wherein said foam layer comprises a closed-cell foam.

6. The water deflector of claim 1, wherein said foam has a thickness in the range of 50 to 500 mils.

7. The water deflector of claim 1, wherein said sheet comprises a high-strength, linear low-density polyethylene film.

8. The water deflector of claim 1, wherein said sheet comprises a high-strength, linear low-density polypropylene film.

9. The water deflector of claim 1, wherein said sheet is bonded to said foam layer via lamination.

10. The water deflector of claim 1, wherein said sheet has a thickness in the range of 1 to 10 mils.

11. The water deflector of claim 1, wherein said foam layer comprises an ethylene vinyl acetate (EVA) foam.

12. The water deflector of claim 11, wherein said foam comprises a 3 mm thick, 4 pound density foam.

13. The water deflector of claim 12, wherein said sheet comprises a 0.0006-inch thick film.

14. A water deflector and vehicle door assembly, comprising:
a vehicle door comprising inner and outer door panels joined about their peripheral edge, having a cavity therebetween;
a water deflector releasably joined to one of said door panels via an adhesive;
wherein said water deflector comprises at least one sheet and a foam layer bonded to said sheet.

15. The water deflector of claim 14, further comprising a plurality of pressure sensitive adhesive bands positioned on a face of said water deflector.

16. The water deflector of claim 14, wherein said sheet comprises an upper edge portion, a lower edge portion, and end edge portions between said upper and lower edge portions.

17. The water deflector of claim 14, wherein said foam layer comprises an open-celled foam.

18. The water deflector of claim 14, wherein said foam layer comprises a closed-cell foam.

19. The water deflector of claim 14, wherein said foam has a thickness in the range of 50 to 500 mils.

20. The water deflector of claim 14, wherein said sheet comprises a high-strength, linear low-density polyethylene film.

21. The water deflector of claim 14, wherein said sheet comprises a high-strength, linear low-density polypropylene film.

22. The water deflector of claim 14, wherein said sheet has a thickness in the range of 1 to 10 mils.

23. The water deflector of claim 14, wherein said foam layer comprises an ethylene vinyl acetate (EVA) foam.

24. The water deflector of claim 23, wherein said foam comprises a 3 mm thick, 4 pound density foam.

25. The water deflector of claim 14, wherein said sheet comprises a 0.0006-inch thick film.

26. The water deflector and vehicle door assembly of claim 14, further comprising a door trim panel extending over the inner door panel and joined thereto.

27. The water deflector and door panel assembly of claim 26, wherein said sheet of said water deflector lies between an opening in said inner door panel and said door trim panel.

28. The water deflector and door panel assembly of claim 26, wherein said sheet is bonded to a face of the foam adjacent the trim panel.

29. The water deflector and door panel assembly of claim 28, further comprising a second sheet bonded to a face of the foam adjacent the inner door panel.
